(19) United States
(12) Patent Application Publication
(10) Pub. No.: US 2010/0008415 A1
(43) Pub. Date: Jan. 14, 2010

(54) MOVING PICTURE CODING APPARATUS, METHOD, PROGRAM, AND INTEGRATED CIRCUIT THEREOF

(76) Inventor: Satoshi Kajita, Fukuoka (JP)

Correspondence Address: WENDEROTH, LIND & PONACK L.L.P., 1030 15th Street, N.W., Suite 400 East, Washington, DC, 20005-1503, US

(21) Appl. No.: 12/526,589

(22) PCT Filed: Dec. 11, 2008
(86) PCT No.: PCT/JP2008/003723

§ 371 Date: Aug. 10, 2009

(30) Foreign Application Priority Data
Dec. 14, 2007 (JP) 2007-322785

(51) Int. Cl. H04N 11/04

(52) U.S. Cl. 375/240.01; 375/E07.001

(57) ABSTRACT

Divided sequences are multiplexed into an output sequence and an index is changed, which requires a process with major throughput.

Accordingly, a transmitting apparatus (3) includes: a dividing unit (5) which divides an input sequence (DV1) into N (N≧2) divided sequences; N coding units which code the N divided sequences divided by the dividing unit (5); and a multiplexing unit (7) which multiplexes, into an output sequence (DS1), the N divided sequences coded by the N coding units, the output sequence (DS1) including an index uniquely specifying a picture out of pictures included in the output sequence (DS1); and an index control unit (610) which sets the index to a divided sequence included in the divided sequences before the divided sequences are multiplexed into the output sequence.

### TECHNICAL FIELD

The present invention relates to a parallel coding apparatus which, in order to process images inputted at high speed, performs parallel coding on N divided sequences that are obtained by dividing an input sequence in a temporal direction for each of N frames, using an N-line coding circuit, and superimposes an N-line coded stream to be outputted in units of a frame in the order of inputting.

### BACKGROUND ART

Operations of a conventional system will be described with reference to FIGS. 1 to 7.

FIG. 1 shows a structure of a conventional moving picture transmission system X1 described in Patent Reference 1. The conventional moving picture transmission system X1 includes a transmitting apparatus X3 and a receiving apparatus X4.

In FIG. 1, the moving picture transmission system X1 divides moving pictures having a high frame rate from the transmitting apparatus X3 to the receiving apparatus X4 via a communication channel X2. Here, the transmitting apparatus X3 employs the H.264 coding scheme.

The transmitting apparatus X3 performs time-axis expansion on input video data XDV1 by sequentially and cyclically distributing the input video data XDV1 for each picture, and generates multiple-line video data XDV1A, XDV1B, . . . , and XDV1N. In addition, the transmitting apparatus X3 causes coding units X6A to X6N to perform a coding process on each of the multiple-line video data XDV1A, XDV1B, . . . , and XDV1N, and then combines the coded video data XDV1A, XDV1B, . . . , and XDV1N into one-line data by time-axis warping. The transmitting apparatus X3 transmits the combined coded data XDS1 to the communication channel X2 via a communication unit that is not illustrated.

To put it differently, in the transmitting apparatus X3, a distributing unit X5 performs the time-axis expansion on each of pictures included in the input video data XDV1 by sequentially and cyclically distributing each picture, and outputs the multiple-line video data XDV1A, XDV1B, . . . , and XDV1N. More specifically, the distributing unit X5 divides an m-th picture included in the input video data XDV1 to first-line video data XDV1A, and then a successive m-th+1 picture to successive second-line video data XDV1B. In addition, the distributing unit X5 further divides a successive m-th+2 picture to successive third-line video data XDV1C.

The coding units X6A to X6N each perform a coding process on a corresponding one of the multiple-line video data XDV1A, XDV1B, . . . , XDV1N according to H.264, and output coded data XDS1A, XDS1B, . . . , and XDS1N.

After performing the time-axis warping on the coded data XDS1A, XDS1B, . . . , and XDS1N, a combining unit X7 sequentially and cyclically selects one of the coded data for each picture so that the selection corresponds to the distribution of the input video data XDV1 performed by the distributing unit X5, and then combines the coded data XDS1A, XDS1B, . . . , and XDS1N into one-line coded data XDS1. Further, the combining unit X7 resets information set to the one-line coded data XDS1 or information pre-set to the multiple-line coded data XDS1A, XDS1B, . . . , and XDS1N, and allows a decoding apparatus compliant with the H.264 coding standard to decode the combined one-line coded data XDS1, the information indicating a relationship of each picture.

The combining unit X7 resets, as the information indicating the relationship of each picture, frame identifiers (frame_num) each identifying a corresponding one of pictures, and makes it possible to identify each picture with the combined coded data XDS1. Stated differently, in H.264, each of the frame identifiers (frame_num), identifiers each unique to a corresponding one of pictures, is set to a corresponding one of slice headers of respective access units, and each picture is identified with the corresponding frame identifier (frame_num). Thus, the unique frame identifiers (frame_num) each are set to the corresponding one of the pictures included in the coded data XDS1A, XDS1B, . . . , and XDS1N on which the coding units X6A to X6N compliant with the H.264 coding standard each perform the coding process.

The combining unit X7 resets, for each picture, a frame identifier (frame_num) included in the combined one-line coded data XDS1 so that a value changes successively, and resets the frame identifiers (frame_num) unique to each coded data XDS1A, XDS1B, . . . , XDS1N to the frame identifiers (frame_num) unique to the one-line coded data XDS1.

FIG. 2 is an outlined line drawing showing setting frame identifiers (frame_num) in the combining unit X7 (FIG. 1) by using, as an example, a case where two-line coded data XDS1A and XDS1B are combined.

In the example shown by FIG. 2, successive frame identifiers (frame-num), value AUn, value AUn+1, value AUn+2, . . . each are sequentially set to a corresponding one of pictures included in the first-line coded data XDS1A (the top row of FIG. 2), and successive frame identifiers (frame_num), value AUm, value AUm+1, value AUm+2, . . . each are sequentially set to a corresponding one of pictures included in the remaining second-line coded data XDS1B (the middle row of FIG. 2).

As indicated by arrow heads, the combining unit X7 generates the one-line coded data XDS1 by combining the two-line coded data XDS1A and XDS1B so that each picture included in the two-line coded data XDS1A and XDS1B is alternately succeeded (the bottom row of FIG. 2). In addition, the combining unit X7 resets a frame identifier (frame_num) for each picture so that a frame identifier (frame_num) of each picture is sequentially succeeded by another frame identifier, as indicated by value AUn, value AUn+1, value AUn+2, value AUn+3, and value AUn+4.

Moreover, the combining unit X7 resets, as information indicating a relationship of each picture, a reference picture list (ref_pic_list) identifying reference pictures, and enables accurately identifying reference relationships with the combined coded data XDS1.

That is to say, in H.264, a reference frame referred to by each of macroblocks is identified with a reference frame identifier (ref_idx) and a reference picture list (ref_pic_list).

FIG. 3 is a schematic diagram showing a structure of a reference picture list XL.

As shown in FIG. 3, the reference picture list XL (ref_pic_list) is a list including reference frame identifiers (ref_idx) of previous pictures and frame identifiers (frame_num) each corresponding to one of the reference frame identifiers (ref_idx), and is set in a slice header. In a coding apparatus and a decoding apparatus compliant with H.264, pictures of the frame identifiers (frame_num) included in the reference picture list XL (ref_pic_list) are stored in a reference picture buffer XB (decoded picture buffer), and utilized for coding and decoding other pictures.

Among the reference frame identifiers (ref_idx) included in the reference picture list XL (ref_pic_list), reference frame identifiers (ref_idx) each corresponding to one of reference pictures are set to respective macroblocks XM.

Thus, in an example shown in FIG. 3, because a reference frame identifier (ref_idx) having value 1 is set to a macroblock XM (ref_idx=1) and the reference frame identifier (ref_idx) having the value 1 is associated with a frame identifier (frame_num) having value n+1 in the reference picture list XL (ref_pic_list), it becomes clear that the macroblock XM refers to a picture whose frame identifier (frame_num) stored in the buffer XB (decoded picture butter) has value n+1.

FIG. 4 is a schematic diagram showing reference relationships in a moving picture coding apparatus (transmitting apparatus X3).

Here, as FIG. 4 shows an example where two-line coded data XDS1A and XDS1B are combined, when multiple-line coded data XDS1A and XDS1B are selected for each picture and combined into one-line coded data, reference relationships between successive pictures change. It is to be noted that, here, in FIG. 4, codes frame_n to frame_n+3 and frame_m to frame_m+3 each indicate a corresponding one of pictures, and directional lines indicate the reference relationships between the pictures. Thus, in the case of FIG. 4, it is indicated that each picture refers to a picture immediately previous to the picture in the two-line coded data XDS1A and XDS1B. When the two-line coded data XDS1A and XDS1B are combined into the one-line coded data, each picture refers to a forward picture with a picture therebetween interposed, and it becomes difficult to accurately indicate the reference relationships with reference relationship information set in each of the two-line coded data XDS1A and XDS1B. In other words, after the coded data XDS1A and XDS1B are combined into the coded data XDS1, the reference relationship information set to each of the coded data XDS1A and XDS1B indicates incorrect reference relationships, that is, wrong reference relationships.

FIGS. 5 and 6 show respective reference relationships of a stream XDS1A before combination and a stream XDS1 after combination, along with state transition of reference picture lists.

In FIG. 5, a reference frame identifier (ref_idx) of each of frames always holds value 0. It is necessary to reset slice header information because the combining unit X7 does not reset a reference frame identifier (ref_idx) referred to by each of macroblocks.

Accordingly, as shown in FIG. 6, the combining unit X7 resets frame identifiers (frame_num) of reference picture lists (ref_pic_list) set to a slice header so that reference relationships can be indicated with the coded data XDS1 which has been combined into one-line. More specifically, the combining unit X7 resets the frame identifiers (frame_num) of the reference picture lists (ref_pic_list) to correspond to setting of the above frame identifiers (frame_num).

FIG. 7 is a diagram showing a structure of a general coded stream compliant with the H.264 coding standard.

The combining unit X7 resets frame identifiers (frame_num) and reference picture lists (ref_pic_list_reordering) included in a slice header. As a result, it is not necessary to reset reference frame identifiers (ref_idx) included in slice data (actually, included in each macroblock data).

### Patent Reference 1: Japanese Unexamined Patent Application Publication No. 2007-202026

### DISCLOSURE OF INVENTION

### Problems that Invention is to Solve

However, with the conventional structure disclosed by above-mentioned Patent Reference 1, the coded data XDS1A to XDS1N each coded by the corresponding one of the coding units X6A to X6N are coded data already structured as access units, and, as shown in FIG. 7, the frame identifiers (frame_num) and the reference frame identifiers (ref_idx) are variable-length coded as slice header syntaxes and macroblock syntaxes, respectively. In order for the combining unit X7 to reset the frame identifiers set to the slice header, it is necessary to detect a start of the slice header in coded data and the frame identifiers while variable-length decoding variable-length coded parameters subsequent to the slice header, and to replace the frame identifiers by variable-length coding frame identifiers to be reset. Moreover, when bit length of variable-length coded data of the frame identifiers to be reset changes, because bit position subsequent to a reset frame identifier shifts, it is necessary to restructure coded data while performing bit shift on the coded data. Further, because it is necessary to reset a reference picture list (ref_pic_list_reordering), it is necessary to variable-length code a variable-length coded stream up to a point where a syntax of the reference picture list appears. For this reason, it is necessary to provide, to a subsequent stage of each of the coding units X6A to X6N or the combining unit X7, a buffer memory which temporarily stores coded data, a start code detector, a stream operating unit which performs a variable-length decoding process, and a barrel shifter which performs bit shift on coded data, and there is a problem that hardware resources and corresponding power consumption increase.

Moreover, in the H.264 coding standard, it is possible to specify the number of referable frames (num_ref_frames), and the maximum value is defined as 16. However, the number of referable frames (num_ref_frames) defines a buffer capacity for storing reference frames of each of the coding units X6A to X6N, and is often limited to equal to or below 16. Thus, when the number of referable frames at the time of coding is limited, there is a problem that a case occurs where, in the coded data XDS1 combined into one-line, a buffer capacity for storing reference frames becomes deficient and no frame data to be referred to is in the buffer because reference frames have already been discarded from a buffer area.

The present invention is devised to solve the above conventional problems, and the objective of the present invention is to provide a moving picture coding apparatus which controls in advance a variable-length coding unit at the time of generating a coded stream in order to maintain compatibility of reference relationships of frames after combination, so as to require no buffer memory which resets parameters already structured as the coded stream, no start code detector, no stream operating unit which performs variable-length decoding, and no barrel shifter which performs bit shift on coded data. In addition, another objective of the present invention is to provide a moving picture coding apparatus with which processes performed are relatively simple.

### Means to Solve the Problems

The present invention has been conceived in consideration of the above, and a moving picture coding apparatus according to a first aspect of the present invention is a moving picture coding apparatus including: a dividing unit configured to divide an input sequence inputted to the moving picture coding apparatus into N (N≧2) divided sequences; N coding units configured to code the N divided sequences divided by the distributing unit; a multiplexing unit configured to multiplex, into an output sequence, the N divided sequences coded by the N coding units, the output sequence including an index uniquely specifying a picture out of pictures included in the output sequence; and an index control unit configured to set the index to a divided sequence included in the divided sequences before the divided sequences are multiplexed into the output sequence.

Furthermore, a moving picture coding apparatus according to a second aspect of the present invention is a moving picture coding apparatus which causes N coding circuits to code N input sequences obtained by selecting an input image every N input images, and which includes: a motion estimation unit configured to obtain motion vector information and difference blocks by estimating a motion based on the input image and images previously coded; an orthogonal transformation unit configured to transform, into a frequency coefficient value, a difference between the blocks estimated by the motion estimation unit; a quantization unit configured to quantize the frequency coefficient value transformed by the orthogonal transformation unit; an inverse quantization unit configured to inverse quantize the value quantized by the quantization unit; an inverse orthogonal transformation unit configured to transform, into a pixel value, the quantization coefficient inverse quantized by the inverse quantization unit; a deblocking filter unit configured to perform a filtering process on the pixel value transformed by the inverse orthogonal transformation; a variable-length coding unit configured to code the coefficient value quantized by the quantization unit, the motion vector value calculated by the motion estimation unit, and coded information including a reference picture index; a reference index information control unit configured to change the reference picture index obtained by the motion estimation unit; and a multiplexing unit configured to multiplex, in an input order, the coding information of the whole of the input sequences and coded streams generated by the N coding circuits

Here, the moving picture coding apparatus according to the second aspect includes a reference frame identifier control unit.

With this structure, it becomes possible to insert a reference frame identifier in a coded stream at the time of generating coded data.

Moreover, a moving picture coding apparatus according to a third aspect of the present invention is the moving picture coding apparatus according to the second aspect which is characterized by including a reference picture buffer information control unit which changes reference picture buffer information included in coded information on a whole input sequence superimposed by the multiplexing unit.

Here, the moving picture coding apparatus according to the third aspect includes the reference picture buffer information control unit.

With this structure, it becomes possible to insert reference frame buffer information (the number of referable frames) in a coded stream at the time of generating coded data.

In addition, provided is a coding method of the moving picture coding apparatus according to the second aspect, and it becomes possible to insert a reference frame identifier in a coded stream at the time of generating coded data.

Furthermore, provided is a coding method of the moving picture coding apparatus according to the third aspect, and it becomes possible to insert the reference frame buffer information (the number of referable frames) in the coded stream at the time of generating the coded data.

Moreover, provided is a program for causing a computer to execute the coding method of the moving picture coding apparatus according to the second aspect, and it becomes possible to insert the reference frame identifier in the coded stream at the time of generating the coded data.

Moreover, provided is a program for causing a computer to execute each of functions of the moving picture coding apparatus according to the third aspect, and it becomes possible to insert the reference frame buffer information (the number of referable frames) in the coded stream at the time of generating the coded data.

Here, a recording medium on which the program for the moving picture coding method of the moving picture coding apparatus according to the second aspect is recorded is a recording medium on which a program for a method including controlling a reference frame identifier is recorded.

Provided is the recording medium on which the program for the coding method is recorded, and it becomes possible to insert the reference frame identifier in the coded stream at the time of generating the coded data.

Here, a recording medium on which the program for the moving picture coding method of the moving picture coding apparatus according to the third aspect is recorded is a recording medium on which a program for a method including controlling a reference frame buffer is recorded.

With this structure, it becomes possible to provide the recording medium on which the program for the coding method in which the reference frame buffer information (the number of referable frames) is inserted in the coded stream at the time of generating the coded data.

### EFFECTS OF THE INVENTION

With the moving picture coding apparatus according to the present invention, it is possible to maintain compatibility of reference relationships when streams that are independently coded are combined without resetting parameters of coded streams. In addition, accordingly, it becomes possible to provide a moving picture coding apparatus with which processes performed are relatively simple.

### BRIEF DESCRIPTION OF DRAWINGS

FIG. 1 is a block diagram showing a conventional moving picture transmission system.

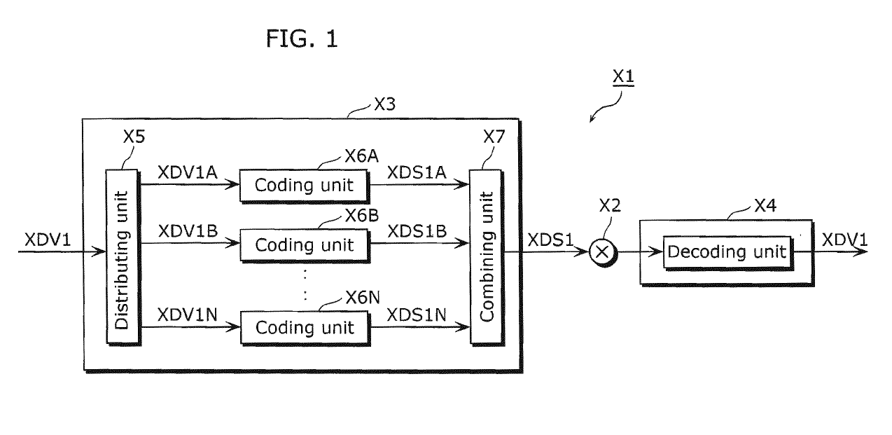

FIG. 2 is a schematic diagram showing a process of combining coded data in a moving picture coding system of FIG. 6.

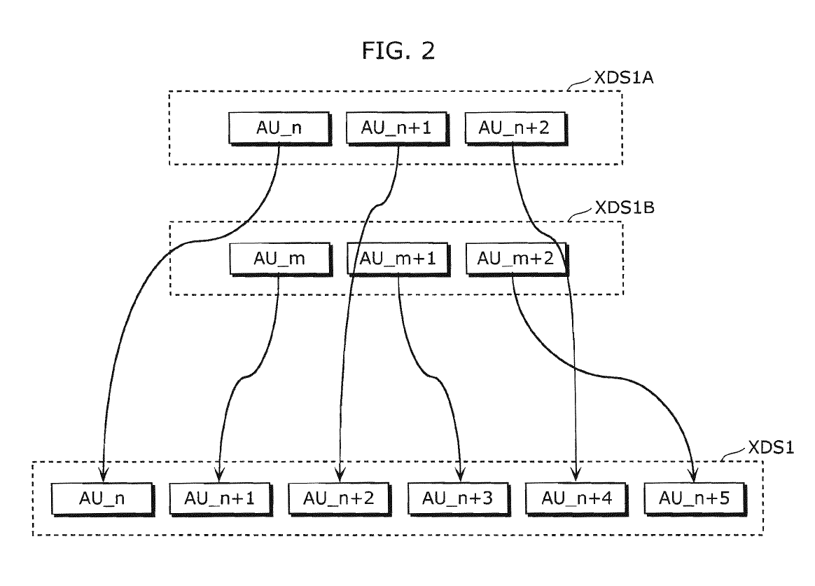

FIG. 3 is a schematic diagram showing a structure of a reference picture list.

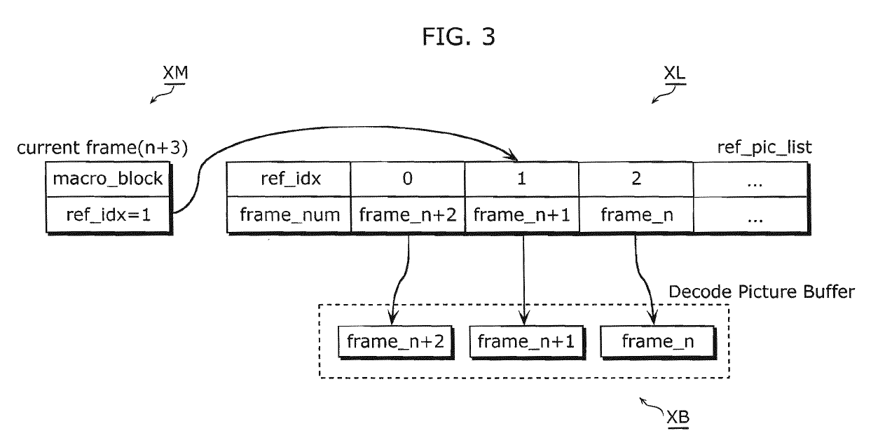

FIG. 4 is a schematic diagram showing reference relationships in a moving picture coding apparatus.

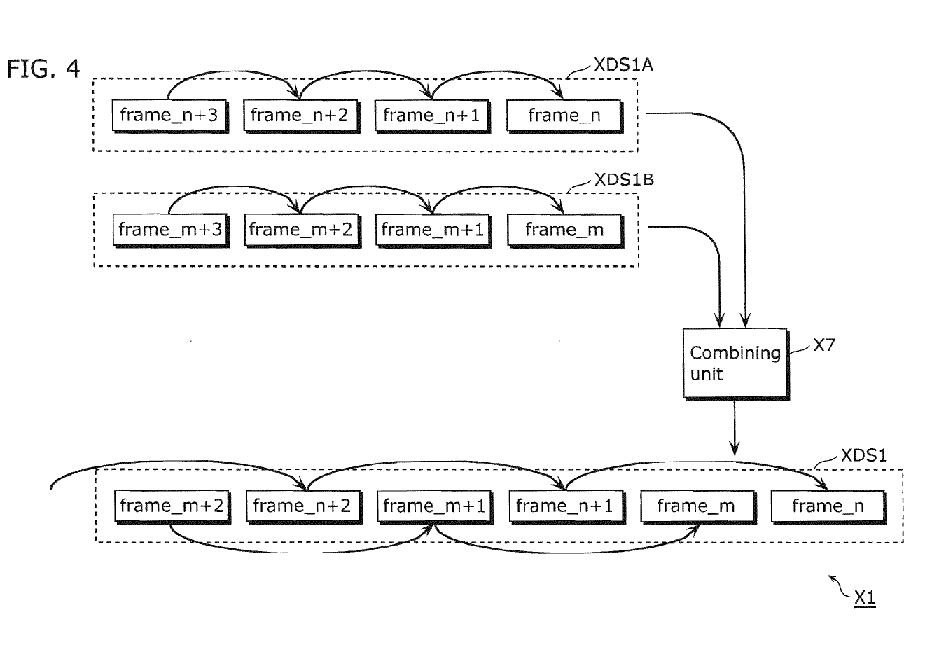

FIG. 5 is a schematic diagram showing that reference relationships of FIG. 9 are described with state transition of a reference frame buffer.

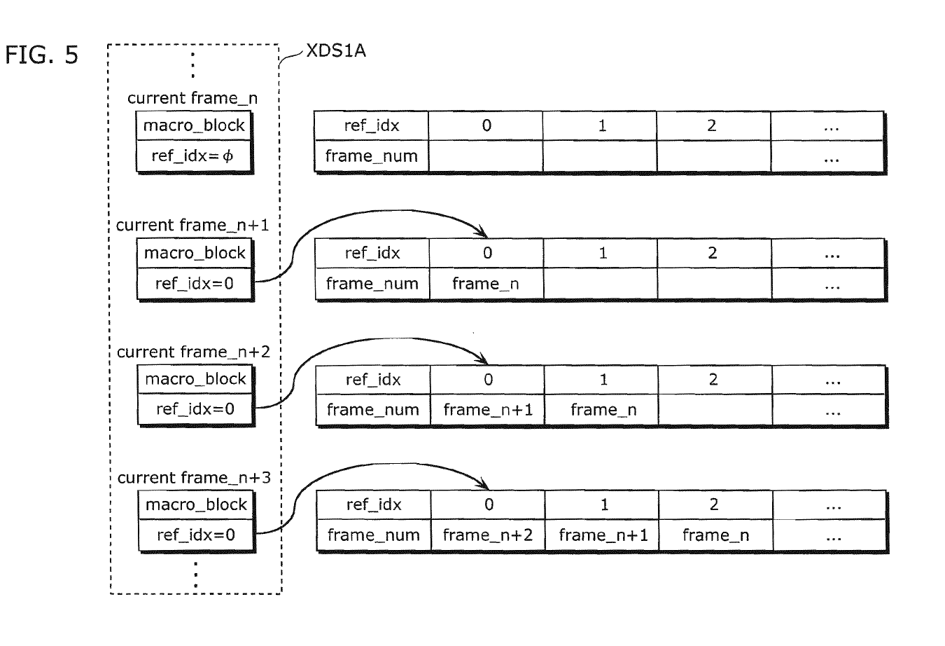

FIG. 6 is a schematic diagram showing state transition of a reference frame buffer in a conventional coding system.

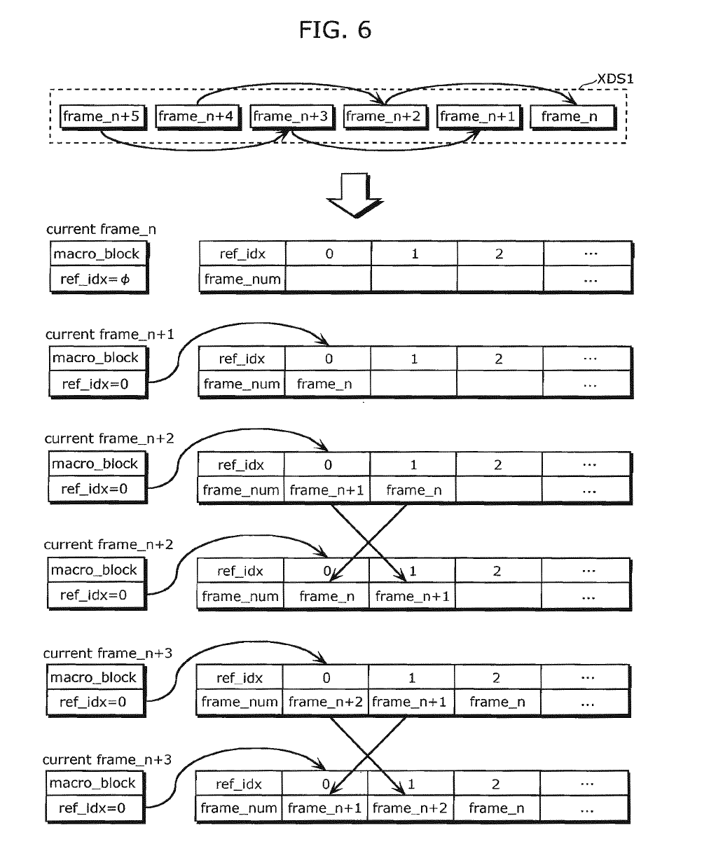

FIG. 7 is a schematic diagram showing a slice layer syntax compliant with the H.264 coding standard.

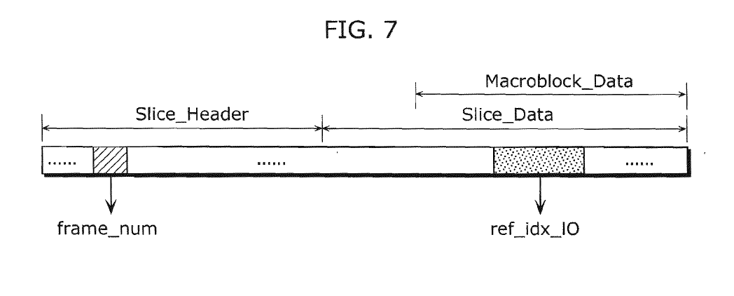

FIG. 8 is a block diagram showing a digital camera set according to an embodiment of the present invention.

FIG. 9 is a block diagram showing a moving picture transmission system according to the embodiment of the present invention.

FIG. 10 is a schematic diagram showing state transition of a reference frame buffer according to the embodiment of the present invention.

FIG. 11 is a schematic diagram showing state transition of the reference frame buffer according to the embodiment of the present invention.

FIG. 12 is a schematic diagram showing state transition of the reference frame buffer according to the embodiment of the present invention.

FIG. 13 is a schematic diagram showing state transition of the reference frame buffer according to the embodiment of the present invention.

FIG. 14 is a flow chart showing reference frame identifier control according to the embodiment of the present invention.

FIG. 15 is a diagram showing divided sequences and an output sequence 154.

### NUMERICAL REFERENCES

1 Digital camera system
2 Communication channel
3 Transmitting apparatus
4 Receiving apparatus
5 Distributing unit
6A to 6N, 6 Coding unit
7 Combining unit
8 Reference frame buffer control unit
601 Orthogonal transformation unit
602 Quantization unit
603 Inverse quantization unit
604 Inverse orthogonal transformation unit
605 Deblocking filter unit
606 Motion estimating unit
607 Intra-prediction unit
608 Variable-length coding unit
609 Frame memory
610 Reference frame identifier control unit
1401 Lens
1402 Image sensor
1403 Image processing processor

### BEST MODE FOR CARRYING OUT THE INVENTION

The following will describe an embodiment of the present invention with reference to drawings.

### Embodiment

The following will describe the embodiment in detail.

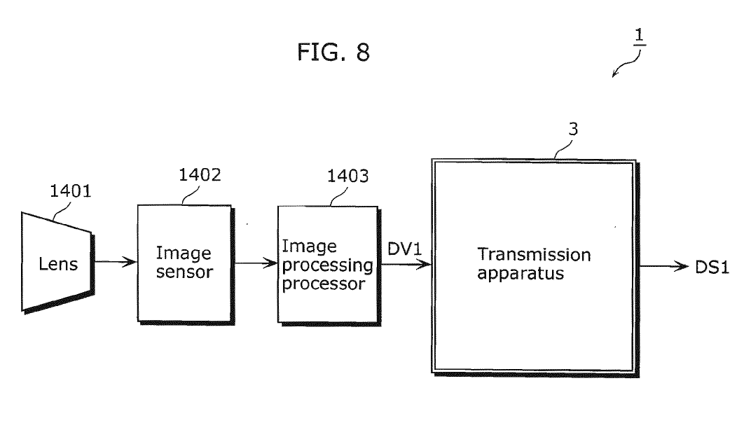

FIG. 8 is a block diagram showing a digital camera system 1.

As shown in FIG. 8, the digital camera system 1 includes: an optical lens 1401; an image sensor 1402; an image processing processor 1403 which is used for preprocessing and converts, into YUV format data DV1, a sensor image (raw data) obtained from the image sensor 1402 by photoelectric conversion; and a transmitting apparatus 3 which codes the YUV format data DV1 transmitted from the image processing processor 1403.

The optical lens 1401 forms, on the image sensor 1402, an image in a moving picture captured by the digital camera system 1.

The image sensor 1402 generates an electrical signal of the image formed by the optical lens 1401. Then, the image sensor 1402 outputs the generated electrical signal to the image processing processor 1403, and inputs the moving picture captured by the digital camera system 1 to the image processing processor 1403. More specifically, the image sensor 1402 generates, for example, an electrical signal of a moving picture having a frame rate higher than a regular frame rate such as a frame rate of television broadcasting, and inputs the moving picture having the high frame rate to the image processing processor 1403.

The image processing processor 1403 performs image processing on the inputted moving picture, and outputs the moving picture after the image processing to the transmitting apparatus 3.

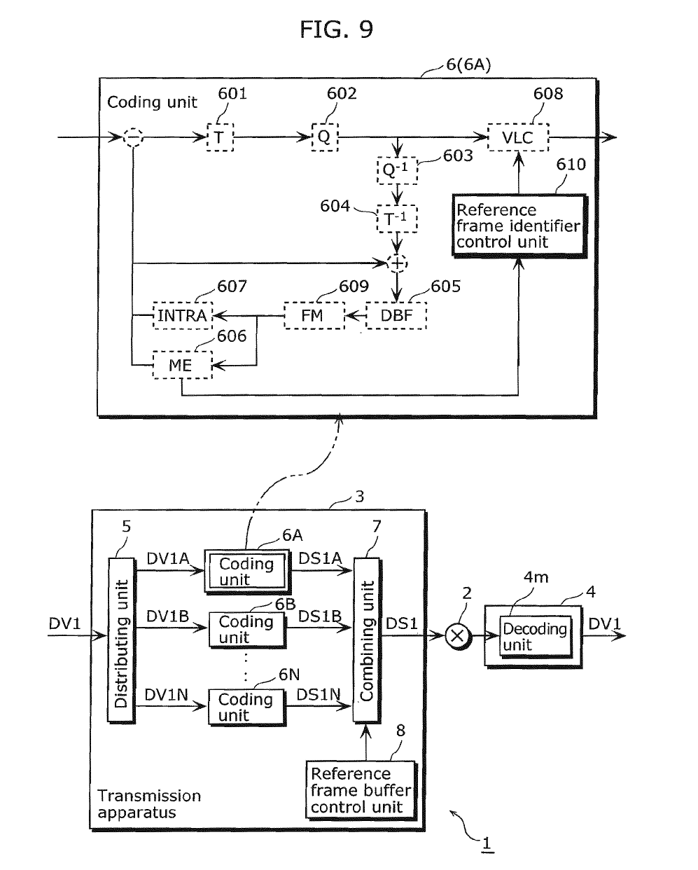

The transmitting apparatus 3 generates an output sequence DS1 (FIG. 9) which is obtained by coding an input sequence DV1 with the H.264 coding scheme, based on the input sequence DV1 (FIG. 8) of the moving picture outputted to the transmitting apparatus 3 from the image processing processor 1403, and transmits the generated output sequence DS1 to a receiving apparatus 4 via a communication channel 2 (FIG. 9).

FIG. 9 is a block diagram showing a detailed structure of the digital camera system 1 according to the embodiment of the present invention.

The bottom row of FIG. 9 shows a detailed structure of the transmitting apparatus 3 (FIG. 8) included in the digital camera system 1.

As the bottom row of FIG. 9 shows, the digital camera system 1 distributes a moving picture having a high frame rate from the transmitting apparatus 3 to the receiving apparatus 4 via the communication channel 2. A moving picture transmission system includes the entirety of the digital camera system 1 and the receiving apparatus 4.

It is to be noted that the receiving apparatus 4 includes a decoding unit 4m. The decoding unit 4m decodes the output sequence DS1 which is transmitted by the transmitting apparatus 3 and received by the receiving apparatus 4. More specifically, the decoding unit 4m decodes the received output sequence DS1 using the H.264 coding scheme. The receiving apparatus 4 causes the decoding unit 4m to decode the received output sequence DS1.

The transmitting apparatus 3 includes a distributing unit 5, decoding units (decoding units 6A to 6N), a combining unit 7, and a reference frame buffer control unit 8 (the bottom row of FIG. 9). It is to be noted that the distributing unit 5 and so on are, for instance, functional blocks mounted on an integrated circuit included by the transmitting apparatus 3. In addition, for example, the distributing unit 5 and so on are functional blocks of functions achieved by a computer executing software, which is included in the transmitting apparatus 3.

The distributing unit 5 performs time-axis expansion on each of pictures of input video data (input sequence) DV1 by sequentially and cyclically distributing each picture, and generates multiple-line video data DV1A, DV1B, . . . , and DV1N. The distributing unit 5 outputs the multiple-line video data DV1A, DV1B, . . . , and DV1N to the decoding units 6A to 6N.

The distributing unit 5 inputs each of the video data DV1A to DV1N divided thereby into a corresponding one of the coding units (decoding units 6A to 6N). The coding units 6A to 6N each code corresponding one of the video data (video data DV1A to DV1N) inputted thereto. The video data DV1A to DV1N coded by the coding units 6A to 6N are called as coded data DS1A to DS1N, respectively.

It is to be noted that the distributing unit 5 divides the input video data DV1 into N divided sequences to be coded by the coding units 6A to 6N. The coding units 6A to 6N each code a corresponding one of the N divided sequences, and output the corresponding one of the N coded divided sequences to the combining unit 7.

It is to be noted that the N divided sequences, which are divided by the distributing unit 5, each have a frame rate lower than a frame rate of the input video data DV1. For instance, the N divided sequences each have a frame rate N times as slow as the frame rate of the input video data DV1. More specifically, for example, a frame rate of each of the N divided sequences is the same as a frame rate of television broadcasting.

The top row of FIG. 9 shows a detailed structure of a coding unit 6.

The coding unit 6 is one of the coding units 6A to 6N (the bottom row of FIG. 9). For instance, the coding unit 6 is the coding unit 6A. Detailed structures of the coding unit 6B to 6N are the same as the detailed structure (the top row of FIG. 9) of the coding unit 6 (coding unit 6A).

The coding unit 6 includes an orthogonal transformation unit (T) 601, a quantization unit (Q) 602, an inverse quantization unit (Q−1) 603, an inverse orthogonal transformation unit (T−1) 604, a deblocking filter unit (DBF) 605, a frame memory (FM) 609, an intra-prediction unit (INTRA) 607, a motion estimating unit (ME) 606, a variable-length coding unit (VLC) 608, and a reference frame identifier control unit 610. Hereinafter, the entirety of the orthogonal transformation unit (T) 601 to the motion estimating unit 606 is called as a front-stage coding unit. The coding unit 6 includes the front-stage coding unit, the variable-length coding unit (VLC) 608, and the reference frame identifier control unit 610.

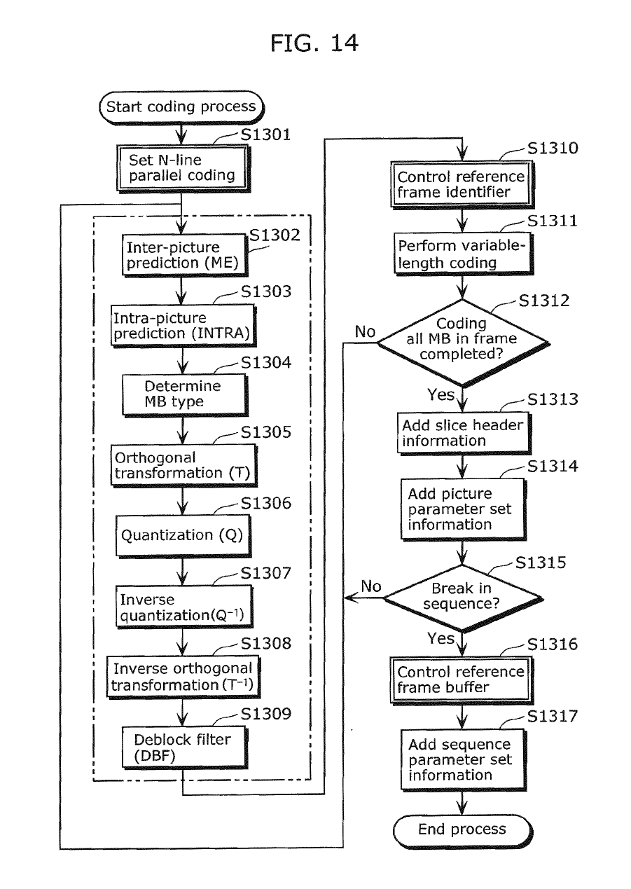

It is to be noted that the variable-length coding unit (VLC) 608 and the front-stage coding unit (the orthogonal transformation unit (T) 601, the quantization unit (Q) 602, the inverse quantization unit (Q−1) 603, the inverse orthogonal transformation unit (T−1) 604, the deblocking filter unit (DBF) 605, the frame memory (FM) 609, the intra-prediction unit (INTRA) 607, and the motion estimating unit (ME) 606) included in the coding unit 6 have functions same as functions in a common H.264 coding process. The variable-length coding unit and the front-stage coding unit may be a variable-length coding unit and a front-stage coding unit to which predetermined corresponding known techniques are applied. A simple flow chart shown by FIG. 14 will describe processing flow of the variable-length coding unit and the front-stage coding unit.

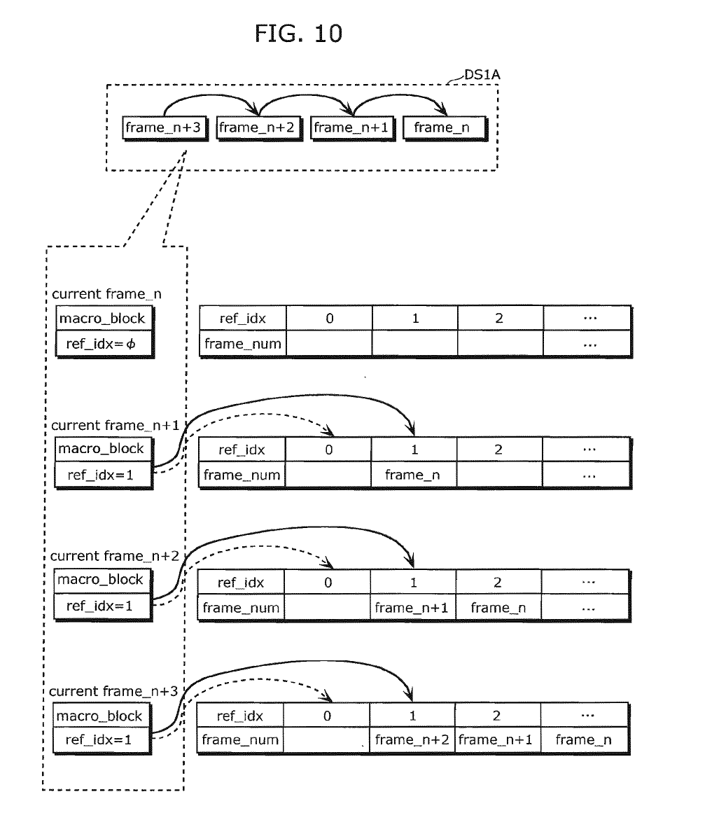

The reference frame identifier control unit 610 and the reference frame buffer control unit 8 will be first described in detail with reference to FIGS. 10 to 13.

After performing time-axis warping on coded data DS1A, DS1B, . . . , and DS1N coded by the coding units 6A to 6N, the combining unit 7 (the bottom row of FIG. 9) sequentially and cyclically selects one of the coded data, on which the time-axis warping is performed, for each picture so that the selection corresponds to the distribution of the input video data DV1 performed by the distributing unit 5. Then, the combining unit 7 combines the coded data DS1A, DS1B, . . . , and DS1N into one-line coded data DS1. The transmitting apparatus 3 transmits the combined coded data DS1 to the receiving apparatus 4.

FIG. 10 is a diagram showing coded data DS1A outputted by the coding unit 6 (the top row of FIG. 9, the coding unit 6A).

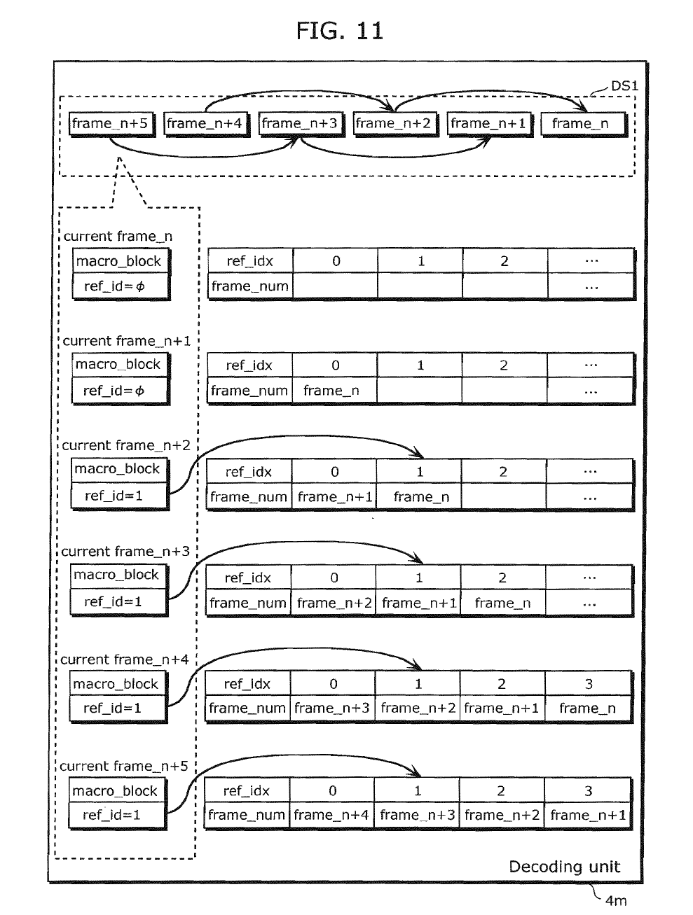

FIG. 11 is a diagram showing coded data DS1 (the bottom row of FIG. 9) combined by the combining unit 7 from the coded data DS1A and so on (FIG. 10).

Operations of the reference frame identifier control unit 610 (the top row of FIG. 9) will be described using FIGS. 10 and 11.

The reference frame identifier control unit 610 (the top row of FIG. 9) sets a global index for uniquely specifying a frame from among each of frames included in the coded data DS1 (the bottom row of FIG. 9 and FIG. 11) to video data XDV1A.

FIG. 10 shows picture reference lists when the coding unit 6 (coding unit 6A) generates the coded stream DS1A shown in FIG. 10.

In addition, FIG. 11 shows an example where combination is performed using N-line (two-line) coding units. FIG. 11 shows a case where N is 2. When coding units have N-line, a reference frame relationship becomes a reference relationship in which N−1 frame (1 frame) is spaced.

In FIG. 10, a frame to which frame_n+2 refers is frame_n+1, and each of frames is generally referred to in ascending order of a frame having the smallest value of a reference frame identifier included in a reference picture list. To put it differently, a reference frame identifier (ref_idx) of frame_n+2 is 0. In FIG. 10, a dashed directional line extending from frame_n+2 shows that ref_idx of frame_n+2 is 0. However, when coding is performed in the above situation, that is, with ref_idx being 0, the coded data DS1 (FIG. 11) combined by the combining unit 7 cannot accurately indicate reference. Accordingly, because the combined coded data DS1 has the reference relationship in which N−1 frame (1 frame) is spaced, when the coding unit 6 (coding unit 6A) performs coding, the reference frame identifier control unit 610 of the coding unit 6 (coding unit 6A) controls in advance the reference frame identifier (ref_idx) so that there is a reference relationship in which 1 frame is spaced, and performs the coding. Stated differently, the reference frame identifier control unit 610 replaces the reference frame relationship shown by the original dashed directional line (FIG. 10) with a reference frame relationship shown by an actual directional line. Thus, for example, as shown by “ref_idx=1” of frame_n+2 in FIG. 10, 0 is replaced with 1 for ref_idx of frame_n+2.

It is to be noted that more specifically, for instance, the reference frame identifier control unit 610 may set a value posterior to replacement after setting a value prior to the replacement, and literally perform a replacement. In addition, the reference frame identifier control unit 610 may immediately set the value posterior to the replacement without setting the value prior to the replacement each time.

It is to be noted that a reference frame identifier identifies a frame to be referred to (reference frame) based on a distance from a frame including the reference frame identifier to a frame to be referred to (reference frame) by the frame, that is, a distance spaced between the frames. The reference frame identifier includes an index indicating a distance from a frame of the reference frame identifier, and identifies the frame having the distance indicated by the index as a reference frame. The reference frame identifier identifies the reference frame with relative specification (self-relative specification).

It is to be noted that the frame including the reference frame identifier may be, for instance, a P-frame (Predicted frame). In addition, the frame including the reference frame identifier may be, for example, a B-frame (Bi-directional predicted frame).

FIG. 11 shows state transition of reference picture lists when the decoding unit 4m (FIG. 9) decodes coded data DS1 which is obtained by combining the coded data DS1A and DS1B and on which the above control is performed.

It is to be noted that FIG. 11 shows a result of newly combining two coded data. To put it differently, coded data obtained by combining other coded data is not the coded data DS1A including frame_n to frame_n+3 shown in FIG. 10, but the coded data DS1 including frame_n to frame_n+5 shown in FIG. 11.

In FIG. 11, in the respective reference picture lists, a smaller reference frame identifier (ref_idx) is assigned to a frame among frame_n to frame_n+5 in order of recentness of a decoding time. Furthermore, because a reference frame identifier (ref_idx) of each frame has a reference relationship in which 2 frames are spaced in the combined coded data DS1, that is, a reference relationship in which 1 frame is spaced in the coded data DS1A before the combination, the decoding unit 4m can perform a frame decoding process based on regular reference relationship information.

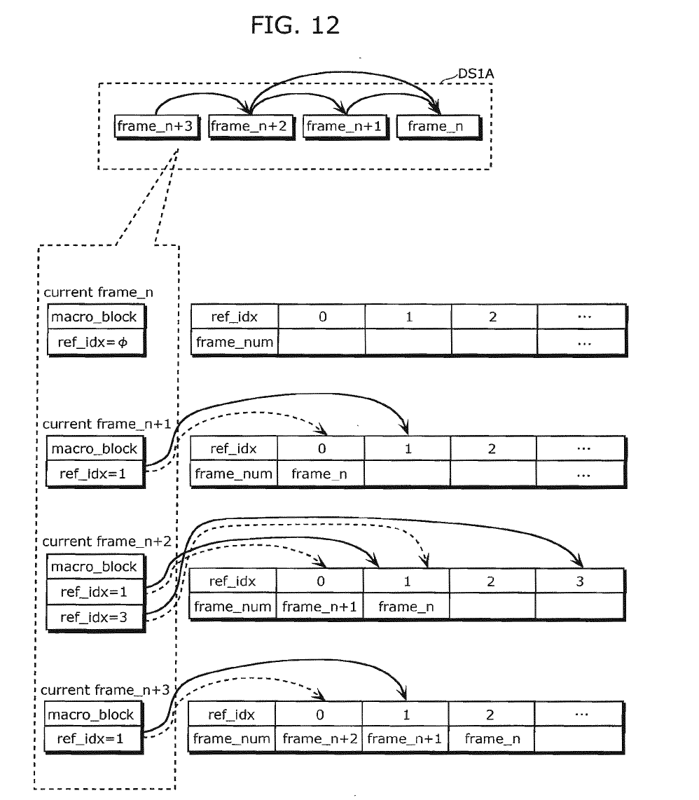

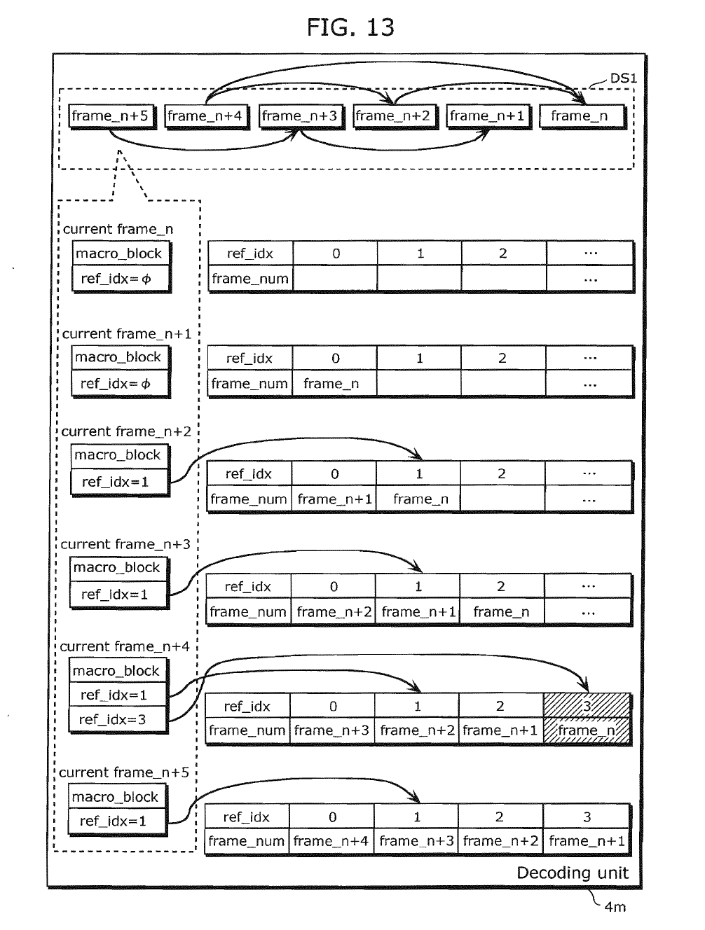

Moreover, the following will describe operations of the transmitting apparatus 3 when there are frame reference relationships with reference to FIGS. 12 and 13.

In FIG. 12, it is assumed that frame_n+2 in a stream (coded data DS1A in FIG. 9) refers to frame_n and frame_n+1. In addition, it is assumed that the maximum value of a reference frame (num_ref_frames) is limited to 3. In this case, the number of frame identifiers (ref_idx) to be referred to is up to 2. FIG. 13 shows state transition of reference picture lists when the combining unit 7 combines two coded streams.

In FIG. 13, a frame identifier (ref_idx) of frame_n+4 is changed so that frame_n+4 refers to frame_n+2 and frame_n. To put it differently, a macroblock of frame_n+4 is the fifth macroblock from the top among six macroblocks macro_block) arranged vertically in FIG. 13. The macroblock of frame_n+4 includes two frame identifiers (ref_idx). As shown by actual directional lines in FIG. 13, the reference frame identifier control unit 610 sets values of the two frame identifiers (ref_idx) not 0 and 1 but 1 and 3, respectively.

The reference frame buffer control unit 8 (the bottom row of FIG. 9) sets the maximum value of the reference frame (num_ref_frames).

When the maximum value of the reference frame (num_ref_frames) remains 3, because the number of frame identifiers (ref_idx) of frame_n which is referred to when decoding frame_n+4 is 3 (ref_idx=3 in FIG. 13), the reference becomes impossible. For this reason, the reference frame buffer control unit 8 (the bottom row of FIG. 9) resets, to (originally-set value×the number of divided frames), the maximum value of the reference frame which is a syntax of a parameter sequence set (Sequence_Parameter_Set) when the combining unit 7 performs combination into one-line, and combines into one-line. As a result, the maximum value of the reference frame reset at the time of the combination becomes 4, and value 3 of the frame identifier (ref_idx) of frame_n, which is referred to at the time of decoding frame_n+4, allows the reference.

Furthermore, a flow chart for a reference frame identifier control process performed by the reference frame identifier control unit 610 and a reference frame buffer control process performed by the reference frame buffer control unit 8 will be described with reference to FIG. 14.

In FIG. 14, first, for instance, the distributing unit 5 and so on of the transmitting apparatus 3 performs, on each coding unit, setting of parallelism N for determining which line coding unit performs a coding process (S1301). Next, the front-stage coding unit (the orthogonal transformation unit (T) 601 and so on) of the coding unit 6A performs the coding process (S1302 to S1309) in accordance with the H.264 standard. Next, the reference frame identifier control unit 610 changes an old frame identifier (ref_idx_OLD) of a frame referred to in an inter-screen prediction process (ME: motion estimation) to a new frame identifier (ref_idx_NEW) (S1310). It is to be noted that the reference frame identifier control unit 610 calculates the frame identifier after the change (ref_idx_NEW) from the frame identifier before the change (ref_idx_OLD) using an equation “ref_idx_NEW=(ref_idx_OLD+1)*N−1”. It is to be noted that the reference frame identifier control unit 610 may first set ref_idx_OLD, and then set ref_idx_NEW by changing the set content of setting to ref_idx_NEW. In other words, after changing an original value to ref_idx_OLD, the reference frame identifier control unit 610 may further change ref_idx_OLD, the changed content of setting, to ref_idx_NEW. In addition, the reference frame identifier control unit 610 may directly change the original value to ref_idx_NEW without changing the original value to ref_idx_OLD.

Next, the variable-length coding unit (VLC) 608 variable-length codes the frame identifier changed by the reference frame identifier control unit 610 in accordance with the H.264 standard (S1311). When coding of all the macroblocks in a frame is completed (S1312), the coding unit and so on add slice header information and picture parameter set information to a stream (S1313 and S1314). When a frame to be coded is the final frame of a sequence (Yes in S1315), the reference frame buffer control unit 8 performs reference frame buffer control (S1316). As mentioned above, this is a process of changing the maximum value of a reference frame and a reference frame holding section. Next, the combining unit 7 adds sequence parameter set information including the changed maximum value of the reference frame (num_ref_frames) to the stream (S1317).

As a conventional problem, there has been a problem that it is necessary to include a stream operating unit, a barrel shifter, and a buffer memory which temporarily stores a stream in order to reset inconsistent reference relationships after combining independently coded streams, and corresponding power consumption increases. The digital camera system 1 allows avoidance of the problem. To put it differently, the transmitting apparatus 3 in the digital camera system 1 includes the reference frame identifier control unit 610 and the reference frame buffer control unit 8, and sets in advance reference relationships after the combination prior to the combination when generating a coded stream, by controlling the variable-length coding unit. This allows providing the moving picture coding apparatus (transmitting apparatus 3) which requires no buffer memory which resets parameters already structured as the coded stream, no start code detector, no stream operating unit which performs variable-length decoding, and no barrel shifter which performs bit shift on coded data.

It is to be noted that although the above-mentioned embodiment has assumed and described the case where the coding process is performed in accordance with the H.264 standard, the present invention is not limited to this, and can be broadly applied to a case where a coding process is performed with different coding schemes in which pictures can be reference pictures.

In addition, although the above-mentioned embodiment has described the case where each of processes is structured with hardware and the hardware is structured as a coding processing terminal, the present invention is not limited to this, and includes a case where each process is structured with hardware and the hardware is structured as an LSI.

Furthermore, a case is included where the hardware is structured through a software process as an embedded program for controlling arithmetic processing of a dedicated digital signal processing processor in the LSI.

Moreover, a case is included where the hardware is structured through a software process as a program for controlling general-purpose arithmetic processing in a personal computer.

In this case, the program for the arithmetic processing may be provided by being recorded on different recording media such as an optical disk, a magnetic disk, a memory card, and an instruction memory in the LSI. In addition, the program may be provided via networks such as the Internet.

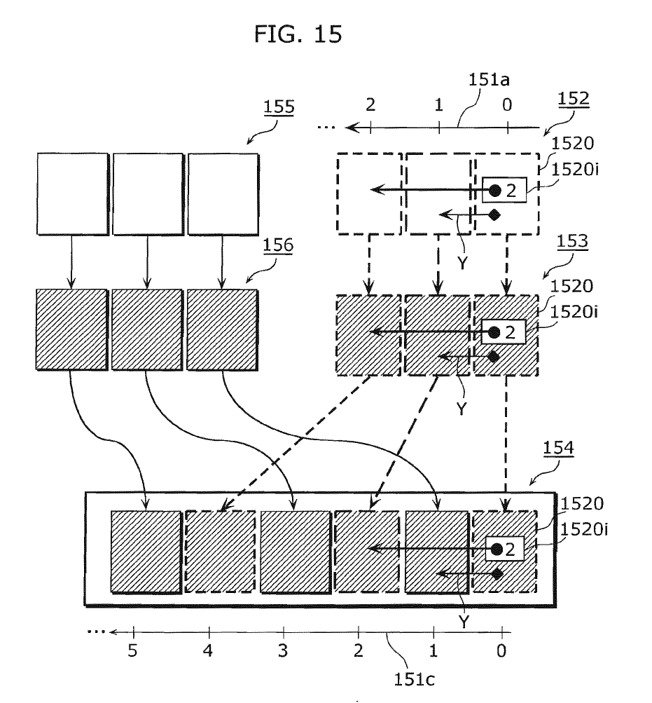

FIG. 15 is a diagram showing divided sequences divided by the distributing unit 5 and an output sequence 154 into which the combining unit 7 combines the divided sequences.

Right-side divided sequences (divided sequences 152 and 153) are divided sequences (video data DV1A and coded data DS1A in FIG. 9) to be coded by the coding unit 6 (coding unit 6A).

The divided sequence 152 is a divided sequence right before the variable-length coding unit 608 (the top row of FIG. 9) performs the variable-length coding on the divided sequence.

The divided sequence 153 is a divided sequence (coded data DS1A) after the variable-length coding unit 608 performs the variable-length coding on the divided sequence. In FIG. 15, hatching applied to the divided sequence 153 indicates that the divided sequence 153 is variable-length coded.

The output sequence 154 is an output sequence (output sequence DS1 in FIG. 9) into which the combining unit 7 combines divided sequences such as the right-side divided sequences and the left-side divided sequences shown in FIG. 15.

The divided sequence 152 includes frames such as a frame 1520.

The frame 1520 is one of the frames included in the divided sequence 152, and is, for example, frame_n+2 in FIG. 10.

The frame 1520 includes a reference frame identifier 1520i set by the reference frame identifier control unit 610 (the top row of FIG. 9).

A number line 151a is a number line for indices of the right-side divided sequences (divided sequences 152 and 153) in FIG. 15, that is, for local indices.

A number line 151c is a number line for indices of the output sequence 154, that is, for global indices.

An index Y is a local index of a frame referred to by the frame 1520. The index Y is an index specifying a frame having a distance of a frame interposed between frames with respect to the frame 1520. The frame referred to by the frame 1520 is a frame having a distance of a frame interposed between frames with respect to the frame 1520. In FIG. 10, the index Y is a reference frame identifier shown by a dashed directional line extending from macro_block of frame_n+2.

It is to be noted that any of the number lines 151a and 151c and the index Y is simply a graphic shown for descriptive purposes, and is not one part of the digital camera system 1.

The reference frame identifier 1520i is a reference frame identifier including a global index specifying on the number line 151c the frame specified by the index Y. In FIG. 10, the reference frame identifier 1520i is shown by an actual directional line extending from macro_block of frame_n+2 and “ref_idx=1” indicated by macro_block of frame_n+2.

The divided sequences 155 and 156 are divided sequences of other coding units, for instance, the coding unit 6B and so on.

In the divided sequences 152 and 153, the frame specified with the local index for the number line 151a by the index Y is the frame specified with the global index for the number line 151c by the reference frame identifier 1520i. In addition, in the divided sequences 152 and 153, the frame specified by the index Y is the frame to be referred to by the frame 1520. Accordingly, even when the reference frame identifier 1520i of the output sequence 154 is not changed each time after the output sequence 154 is obtained by the combining, the reference frame identifier 1520i includes appropriate contents. Thus, when the decoding unit 4m decodes the output sequence 154, the decoding unit 4m properly decodes the frame 1520 of the output sequence 154 based on the reference frame identifier 1520i.

As described above, a moving picture coding apparatus (the transmitting apparatus 3, a computer of the transmitting apparatus 3, an integrated circuit of the transmitting apparatus 3, and so on) is structured to include: a dividing unit (the distributing unit 5 shown at the bottom row of FIG. 9) configured to divide an input sequence inputted to the moving picture coding apparatus into N (N≧2) divided sequences (the left-side divided sequence and the right-side divided sequence shown in FIG. 15); N coding units (the coding units 6A to 6N shown at the bottom row of FIG. 9) configured to code the N divided sequences divided by the dividing unit; a multiplexing unit (the combining unit 7 shown at the bottom row of FIG. 9) configured to multiplex, into an output sequence (the output sequence DS1 and the output sequence 154), the N divided sequences coded by the N coding units, the output sequence including an index (the reference frame identifier 1520i and the reference picture index) uniquely specifying a picture out of pictures included in the output sequence; and an index control unit (the reference frame identifier control unit 610 shown at the bottom row of FIG. 9) configured to set the index to a divided sequence included in the divided sequences before the divided sequences are multiplexed into the output sequence.

It is to be noted that, here, the term “uniquely” means not that an index specifies specific images from among images and each of the specific images but that an index specifies only a specific image from among images.

With the above structure, the moving picture coding apparatus (the transmitting apparatus 3 shown at the bottom row of FIG. 9) according to the present embodiment sets the index before the multiplexing unit performs the multiplexing. Accordingly, performing a simple process sets the index without major throughput.

Furthermore, structured is the moving picture coding apparatus, wherein the number of the index control units is N, each of the N index control units is: provided to a corresponding one of the coding units; and configured to set, to the divided sequence, the index (the reference frame identifier 1520i and the reference picture index) specifying the picture (the reference frame) included in the divided sequence before the divided sequences including the divided sequence coded by the coding unit, to which the index control unit is provided, are multiplexed into the output sequence, the multiplexing unit is configured to multiplex the N divided sequences into the output sequence in which an s-th picture (where s is an integer number) in a divided sequence coded by a t-th coding unit (1≦=t≦IN) is in (s×N+t+At)th order (where At (1≦t≦N) is a constant number) (refer to FIG. 15), and the t-th index control unit (1≦t≦N) provided to the t-th coding unit (1≦t≦N) is configured to set an index indicating the (s×N+t+At)th order with respect to s-th order in which the picture is included in the divided sequence and t-th order.

It is to be noted that, as mentioned above, ref_idx_NEW and ref_idx_OLD have a “ref_idx_New=(ref_idx_OLD+1)*N−1” relationship.

Moreover, structured is the moving picture coding apparatus, wherein the dividing unit is configured to select a selection value from among values (1 to N) equal to or below N, depending on, for instance, high-speed shooting or regular-speed shooting performed by the digital camera system 1, and divide the input sequence into divided sequences by a number equal to the selected selection value, coding units, a number of which is equal to the selection value, among the N coding units, are configured to code the divided sequences which the dividing unit has divided by the number equal to the selection value, the multiplexing unit is configured to multiplex, into the output sequence, the divided sequences which are coded by the coding units, the number of which is equal to the selection value, and which are divided by the number equal to the selection value, the number of the index control units is N, and each of the N index control units is: provided to a corresponding one of the coding units; and configured to set, to the divided sequence, the index specifying the picture included in the divided sequence before the divided sequences including the divided sequence coded by the coding unit, to which the index control unit is provided, are multiplexed into the output sequence, when the coding units, the number of which is equal to the selection value, include the coding unit to which the index control unit is provided.

It is to be noted that the dividing unit selects a selection value for high-speed shooting which is a value greater than a regular selection value for regular-speed shooting, when the high-speed shooting is performed.

Furthermore, structured is the moving picture coding apparatus that is an integrated circuit (the integrated circuit included in the transmitting apparatus 3), wherein the integrated circuit is provided in an imaging device (the digital camera system 1) which images a moving picture, the integrated circuit receiving the input sequence which is inputted thereto and indicates the moving picture imaged by the imaging device, the imaging device images a first moving picture and a second moving picture having the number of pictures (for instance, 60×N) included per unit time greater than the first moving picture has (for example, 60), and the dividing unit is configured to select a second selection value (for instance, N) when the imaging device images the second moving picture, the second selection value being greater than a first selection value (for instance, 1) selected when the imaging device images the first moving picture.

Moreover, structured is the moving picture coding apparatus including a buffer information control unit (the reference frame buffer control unit 8 shown at the bottom row of FIG. 9) configured to set buffer information (the reference frame maximum value (num_ref_frames)) to the output sequence which includes the buffer information with which a moving picture decoding apparatus specifies a size for a buffer (DPB: Decoded Picture Buffer) which stores a picture identified with the index, when the moving picture decoding apparatus decodes the output sequence.

Furthermore, structured is the moving picture coding apparatus including a buffer information control unit configured to set buffer information to the output sequence, wherein the buffer information control unit is configured to set, to the output sequence, the buffer information specifying a larger size for a buffer as the selection value which indicates the number of the index control units setting the index is higher, and the output sequence includes the buffer information with which a moving picture decoding apparatus specifies a size for the buffer which stores a picture identified with the index, when the moving picture decoding apparatus decodes the output sequence.

Moreover, structured is the moving picture coding apparatus, wherein each of the N coding units includes: the index control unit provided to the coding unit; an index necessary coding unit (the front-stage coding unit: the orthogonal transformation unit (T) 601; the quantization unit (Q) 602; the inverse quantization unit (Q−1) 603; the inverse orthogonal transformation unit (T−1) 604; the deblocking filter unit (DBF) 605; the frame memory (FM) 609; the motion estimating unit (ME) 606; and the intra-prediction unit (INTRA) 607) configured to perform, on a divided stream, coding in which the index set by the coding unit becomes necessary to a moving picture decoding apparatus (the decoding unit 4m), when the moving picture decoding apparatus decodes the output sequence; and a variable-length coding unit (the variable-length coding unit 608) configured to variable-length code the divided stream coded by the index necessary coding unit, and the index control unit is configured to set the index to the divided stream before the variable-length coding unit variable-length codes the divided stream.

Furthermore, structured is the moving picture coding apparatus, wherein the index necessary coding unit includes: an inverse quantization unit (the inverse quantization unit (Q−1) 603) configured to inverse quantize, into a frequency coefficient value, a quantization value obtained by quantizing a frequency coefficient value of a previous picture; an inverse orthogonal transformation processing unit (the inverse orthogonal transformation unit (T−1) 604) configured to determine the past picture indicated by the frequency coefficient value inverse quantized by said inverse quantization unit, based on the frequency coefficient value; a deblocking filter (the deblocking filter (DBF) 605) which performs a deblocking filter process on the past picture determined by said inverse orthogonal transformation processing unit; an estimating unit (the intra-prediction unit (INTRA) 607) configured to calculate an estimated picture of a current picture from the past picture on which said deblocking filter has performed the deblocking filter process; an orthogonal transformation unit (the orthogonal transformation unit (T) 601) configured to transform a difference between the current picture and the estimated picture calculated by said estimating unit into a frequency coefficient value; and a quantization unit (the quantization unit (Q) 602) configured to quantize the frequency coefficient value transformed by said orthogonal transformation unit into a quantization value, the variable-length coding unit (the variable-length coding unit (VLC) 608) is configured to variable-length code coded information including the quantization value quantized by said quantization unit, and the index control unit is configured to set an index specifying the past picture to the coded information variable-length coded by said variable-length coding unit, and cause said variable-length coding unit to variable-length code the coded information to which the index is set.

Moreover, structured is the moving picture coding apparatus, wherein the output sequence (the output sequence DS1 shown in FIG. 9 and the output sequence 154 shown in FIG. 15) is a sequence obtained by coding the input sequence in accordance with the H.264 coding standard.

### INDUSTRIAL APPLICABILITY

The moving picture coding apparatus according to the present invention is useful as, for instance, an image system which performs a coding process on a picture imaged at high speed by using H.264 coding.

It is possible to provide a moving picture coding apparatus in which processes performed by the moving picture coding apparatus are simple.

1. A moving picture coding apparatus comprising:
a dividing unit configured to divide an input sequence inputted to said moving picture coding apparatus into N (N≧2) divided sequences;
N coding units configured to code the N divided sequences divided by said dividing unit;
a multiplexing unit configured to multiplex, into an output sequence, the N divided sequences coded by said N coding units, the output sequence including an index uniquely specifying a picture out of pictures included in the output sequence; and
an index control unit configured to set the index to a divided sequence included in the divided sequences before the divided sequences are multiplexed into the output sequence.

2. The moving picture coding apparatus according to claim 1,
wherein the number of said index control units is N,
each of said N index control units is:
provided to a corresponding one of said coding units; and
configured to set, to the divided sequence, the index specifying the picture included in the divided sequence before the divided sequences including the divided sequence coded by said coding unit, to which said index control unit is provided, are multiplexed into the output sequence,
said multiplexing unit is configured to multiplex the N divided sequences into the output sequence in which an s-th picture (where s is an integer number) in a divided sequence coded by a t-th coding unit (1≦t≦N) is in (s×N+t+At)th order (where At (1≦t≦N) is a constant number), and
said t-th index control unit (1≦t≦N) provided to said t-th coding unit (1≦t≦N) is configured to set an index indicating the (s×N+t+At)th order with respect to s-th order in which the picture is included in the divided sequence and t-th order.

3. The moving picture coding apparatus according to claim 1,
wherein said dividing unit is configured to select a selection value from among values equal to or below N, and divide the input sequence into divided sequences by a number equal to the selected selection value,
coding units, a number of which is equal to the selection value, among said N coding units, are configured to code the divided sequences which said dividing unit has divided by the number equal to the selection value,
said multiplexing unit is configured to multiplex, into the output sequence, the divided sequences which are coded by said coding units, the number of which is equal to the selection value, and which are divided by the number equal to the selection value,
the number of said index control units is N, and
each of said N index control units is:
provided to a corresponding one of said coding units; and
configured to set, to the divided sequence, the index specifying the picture included in the divided sequence before the divided sequences including the divided sequence coded by said coding unit, to which said index control unit is provided, are multiplexed into the output sequence, when said coding units, the number of which is equal to the selection value, include said coding unit to which said index control unit is provided.

4. The moving picture coding apparatus according to claim 3,
wherein said moving picture coding apparatus is an integrated circuit,
said integrated circuit is provided in an imaging device which images a moving picture, said integrated circuit receiving the input sequence which is inputted thereto and indicates said moving picture imaged by the imaging device,
said imaging device images a first moving picture and a second moving picture having the number of pictures included per unit time greater than the first moving picture has, and
said dividing unit is configured to select a second selection value when said imaging device images the second moving picture, the second selection value being greater than a first selection value selected when said imaging device images the first moving picture.

5. The moving picture coding apparatus according to claim 1, comprising
a buffer information control unit configured to set buffer information to the output sequence,
wherein the output sequence includes the buffer information with which a moving picture decoding apparatus specifies a size for a buffer which stores a picture identified with the index, when the moving picture decoding apparatus decodes the output sequence.

6. The moving picture coding apparatus according to claim 3, comprising
a buffer information control unit configured to set buffer information to the output sequence,
wherein said buffer information control unit is configured to set, to the output sequence, the buffer information specifying a larger size for a buffer as the selection value which indicates the number of said index control units setting the index is higher, and
the output sequence includes the buffer information with which a moving picture decoding apparatus specifies a size for the buffer which stores a picture identified with the index, when the moving picture decoding apparatus decodes the output sequence.

7. The moving picture coding apparatus according to claim 1,
wherein the number of said index control units is N,
each of said N index control units is:
provided to a corresponding one of said coding units; and
configured to set, to the divided sequence, the index specifying the picture included in the divided sequence before the divided sequences including the divided sequence coded by said coding unit, to which said index control unit is provided, are multiplexed into the output sequence,
each of said N coding units includes:
said index control unit provided to said coding unit;
an index necessary coding unit configured to perform, on a divided stream, coding in which the index set by said coding unit becomes necessary to a moving picture decoding apparatus, when the moving picture decoding apparatus decodes the output sequence; and
a variable-length coding unit configured to variable-length code the divided stream coded by said index necessary coding unit, and
said index control unit is configured to set the index to the divided stream before said variable-length coding unit variable-length codes the divided stream.

8. The moving picture coding apparatus according to claim 7,
wherein said index necessary coding unit includes:
an inverse quantization unit configured to inverse quantize, into a frequency coefficient value, a quantization value obtained by quantizing a frequency coefficient value of a previous picture;
an inverse orthogonal transformation processing unit configured to determine the past picture indicated by the frequency coefficient value inverse quantized by said inverse quantization unit, based on the frequency coefficient value;
a deblocking filter which performs a deblocking filter process on the past picture determined by said inverse orthogonal transformation processing unit;
an estimating unit configured to calculate an estimated picture of a current picture from the past picture on which said deblocking filter has performed the deblocking filter process;
an orthogonal transformation unit configured to transform a difference between the current picture and the estimated picture calculated by said estimating unit into a frequency coefficient value; and
a quantization unit configured to quantize the frequency coefficient value transformed by said orthogonal transformation unit into a quantization value,
wherein said variable-length coding unit is configured to variable-length code coded information including the quantization value quantized by said quantization unit, and
said index control unit is configured to set an index specifying the past picture to the coded information variable-length coded by said variable-length coding unit, and cause said variable-length coding unit to variable-length code the coded information to which the index is set.

9. The moving picture coding apparatus according to claim 1,
wherein the output sequence is a sequence obtained by coding the input sequence in accordance with the H.264 coding standard.

10. A moving picture coding method comprising:
dividing an input sequence into N (N≧2) divided sequences;
coding, with N coding units, the N divided sequences divided in said dividing;
multiplexing, into an output sequence, the N divided sequences coded in said coding, the output sequence including an index uniquely specifying a picture out of pictures included in the output sequence;
setting the index to a divided sequence included in the divided sequences before the divided sequences are multiplexed into the output sequence.

11. A computer program causing a computer to execute:
dividing an input sequence into N (N≧2) divided sequences;
coding, with N coding units, the N divided sequences divided in said dividing;
multiplexing, into an output sequence, the N divided sequences coded in said coding, the output sequence including an index uniquely specifying a picture out of pictures included in the output sequence; and
setting the index to a divided sequence included in the divided sequences before the divided sequences are multiplexed into the output sequence.

12. An integrated circuit comprising:
a dividing unit configured to divide an input sequence into N (N≧2) divided sequences;
N coding units configured to code the N divided sequences divided by said dividing unit;
a multiplexing unit configured to multiplex, into an output sequence, the N divided sequences coded by said N coding units, the output sequence including an index uniquely specifying a picture out of pictures included in the output sequence; and
an index control unit configured to set the index to a divided sequence included in the divided sequences before the divided sequences are multiplexed into the output sequence.
